(19) United States
(12) Patent Application Publication
(10) Pub. No.: US 2009/0225223 A1
(43) Pub. Date: Sep. 10, 2009

(54) SYSTEM AND METHOD FOR ACCOMMODATING SUBMISSIONS OF INVALID SYSTEM TIME TABLE INFORMATION

(75) Inventors: Steven L. Cooper, Whitestown, IN (US); Bret D. Hawkins, Brownsburg, IN (US)

Correspondence Address: FLETCHER YODER P.C., 7915 FM 1960 RD. WEST, SUITE 330, HOUSTON, TX, 77070, US

(73) Assignee: SHENZHEN TCL NEW TECHNOLOGY LTD, Shenzhen (CN)

(21) Appl. No.: 12/093,308

(22) PCT Filed: Nov. 16, 2006
(86) PCT No.: PCT/US06/44613

§ 371 Date: May 9, 2008

(51) Int. Cl. H04N 9/475

(52) U.S. Cl. 348/510; 348/E05.009

(57) ABSTRACT

There is provided a system and method for accommodating submissions of invalid system time table information. More specifically, in one embodiment, there is provided a method comprising receiving a first video-based time signal from a video source, determining a first CPU-based time signal, receiving a second video-based time signal from the video source, determining a second CPU-based time signal, subtracting the first video-based time signal from the second video-based time signal to produce a first time difference, subtracting the first CPU-based time signal from the second CPU-based time signal to produce a second time difference, and accepting the video source as a valid time source if the first time difference substantially matches the second time difference.

### FIELD OF THE INVENTION

The present invention relates generally to transmission and display of system time table information on television systems.

### BACKGROUND OF THE INVENTION

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

A System Time Table (STT) may be defined as a data structure including time information (e.g., current date and time data) that is submitted to a receiving device (e.g., a television) from a broadcaster, video source, or provider (e.g., a cable head-end or a terrestrial broadcaster) to facilitate synchronization with the receiving device or to update time settings on the device. For example, a provider may transmit an STT once per second to all of the devices receiving a signal from the provider to synchronize them to a current time of day. The STT typically indicates whether or not Daylight Saving Time is in effect, and signals the day and hour for transitions into and out of Daylight Saving Time. Time in the STT is generally represented as the count of Global Position System (GPS) time seconds that have occurred since 00:00:00 Jan. 6, 1980. Both the American National Standards Institute/Society of Cable Telecommunications Engineers (ANSI/SCTE) 65 standard and the ATSC (Advanced Television Systems Committee) 65 standard specify an STT for transmitting GMT (Greenwich Mean Time) from providers to receiving devices.

Often, STTs sent by providers include invalid data and should not be used for displaying time or date values to a user. Indeed, the use of invalid STTs for such purposes can confuse a user because, depending on the channel being viewed, radically different time and date values may be displayed. For example, the STT sent by a particular provider may be incorrect because it was created for a recorded stream that is being played in a loop. In another example, broadcast equipment may not set or update the time information, which may result in either setting the time to an STT start date (e.g., 00:00:00 Jan. 6, 1980) or some arbitrary date that does not change. In yet another example, the STT may include time information that is simply incorrect. Accordingly, it is now recognized that a system and method for detecting and ignoring an invalid STT may be desirable.

### SUMMARY OF THE INVENTION

Certain aspects commensurate in scope with the disclosed embodiments are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

There is provided a system and method for accommodating submissions of invalid system time table information. More specifically, in one embodiment, there is provided a method comprising receiving a first video-based time signal from a video source, determining a first CPU-based time signal, receiving a second video-based time signal from the video source, determining a second CPU-based time signal, subtracting the first video-based time signal from the second video-based time signal to produce a first time difference, subtracting the first CPU-based time signal from the second CPU-based time signal to produce a second time difference, and accepting the video source as a valid time source if the first time difference substantially matches the second time difference.

### BRIEF DESCRIPTION OF THE DRAWINGS

Advantages of the invention may become apparent upon reading the following detailed description and upon reference to the drawings in which:

FIG. 1 is a block diagram of an electronic device in accordance with an exemplary embodiment of the present invention;

FIG. 2 is a process flow diagram that represents processing time and date information in accordance with an exemplary embodiment of the present invention; and

FIG. 3 is a process flow diagram that represents a method for acquiring and processing time information in accordance with and exemplary embodiment of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

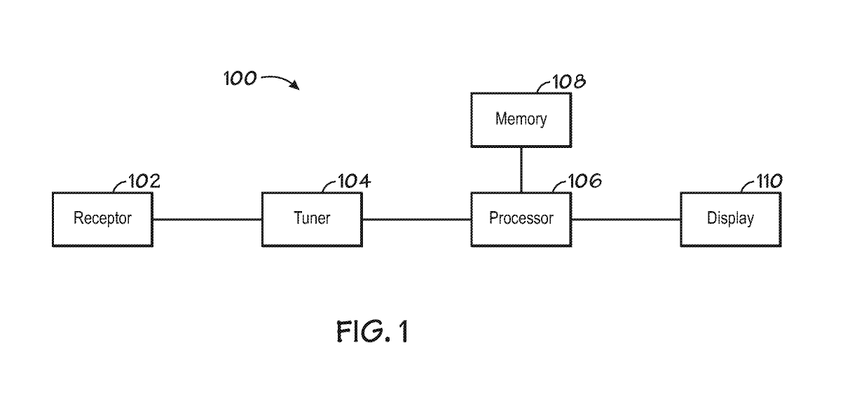

FIG. 1 is a block diagram of an electronic device in accordance with an exemplary embodiment of the present invention. The electronic device (e.g., a television) is generally designated by reference numeral 100. The electronic device 100 comprises a receptor (e.g., a cable inlet or an antenna) 102, a tuner 104, a processor 106, a memory 108, and a display 110. The receptor 102 may be adapted to receive signals from a video source or provider (e.g., a terrestrial broadcaster or a cable head-end). The tuner 104 may be adapted to facilitate selection of certain provider signals for presentation on the display 110. The memory 108 may be adapted to hold machine-readable computer code that causes the processor 106 to perform an exemplary method in accordance with the present invention.

In accordance with present embodiments, a system time and date feature (e.g., a clock graphic on the display 110 that is viewable by a user) may be set based upon an incoming data source. For example, a provider may transmit time information to a television in any of various standard formats, such as Extended Data System (XDS), Advanced Television Systems Committee (ATSC), Program and System Information Protocol (PSIP), or Society of Cable Telecommunication Engineers (SCTE) 65 cable time. In some embodiments, the time and date information is set based on an incoming STT. For a terrestrial broadcast, the STT may be included in the Program and System Information Protocol (PSIP) portion of the program information. It should be noted that this information is typically sent in addition to basic tables that are required to play audio and video for a given digital program, such as those provided by Moving Picture Experts Group-2 (MPEG-2) data. For a cable broadcast, the STT may come from either an in-band transmission or an out-of-band (OOB) signal. The in-band cable STT may be very similar to the terrestrial PSIP STT. The OOB cable STT may only be available from an optional CableCard in a Digital-Cable-Ready (DCR) system.

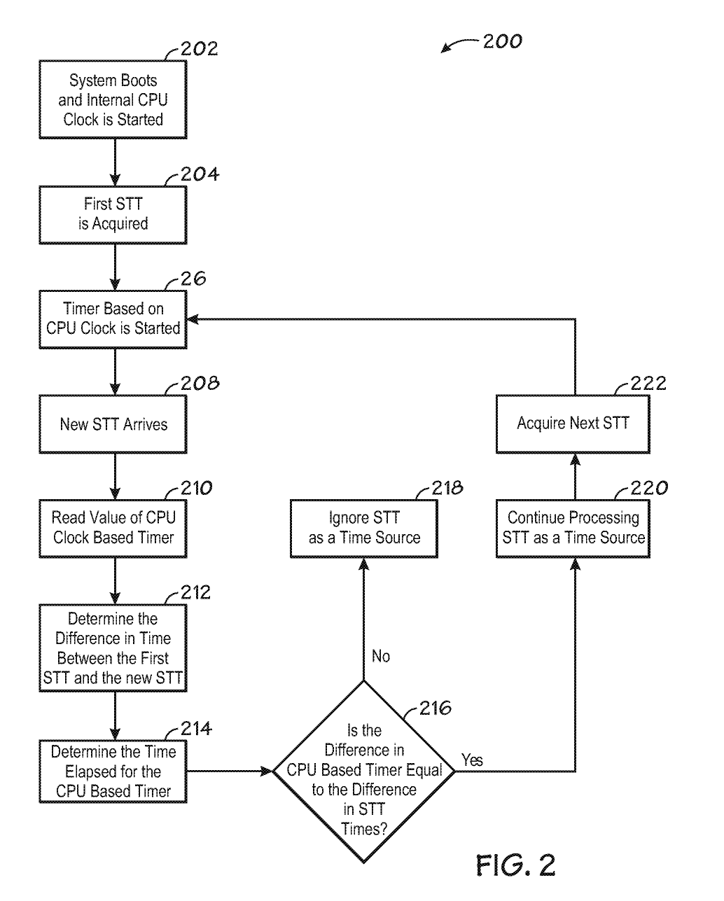

FIG. 2 is a process flow diagram that represents processing time and date information in accordance with an exemplary embodiment of the present invention. The exemplary process in FIG. 2 is generally designated by reference numeral 200 and may be implemented by a system or device (e.g., device 100) in accordance with present embodiments. The process 200 generally compares the progression of time information from a provider (e.g., a video-based time signal) with the progression of a system clock to determine if the provider information is valid.

According to process 200, a source that provides time information that does not progress at a sufficiently accurate rate may be ignored (e.g., not utilized for time and date display purposes). For example, process 200 may compare a video-based time signal (e.g., time information in an incoming STT) with a central processing unit (CPU)-based time signal (e.g., time information from a system clock that is based on a CPU frequency). Such a system clock will not typically provide a current time, but will provide a fairly accurate measurement of time since boot-up of the system. To compare the two different sets of time information, a first received STT may be stored along with a value of the base system clock. When a second STT arrives, the difference between it and the first STT (i.e., the stored STT) should agree or substantially agree (e.g., agree within a user-defined tolerance) with the progress of the system clock. If the data in the new STT is unchanged, the process 200 may deem the related source invalid. Further, if the time difference between the first and second STTs does not agree or substantially agree with the system clock, the source may be deemed invalid. It should be noted that CPU frequency time based clocks are generally available in embedded systems.

In the exemplary embodiment illustrated in FIG. 2, the process 200 begins with a system boot and initiation of an internal CPU clock, as illustrated by block 202. In block 204, a first STT is acquired. Upon acquiring the first STT, a timer based on the CPU clock is started, as shown in block 206. In block 208, a second STT is received. Upon receiving the new STT, a value of the CPU-based timer is determined in block 210. A difference is determined between the first STT and the second STT, as illustrated by block 212. Similarly, an elapsed time of the CPU-based timer for the time period between acquiring the first STT and the second STT is determined in block 214. In block 216, a determination is made as to whether the difference in the CPU based timer is equal (or substantially equal) to the difference in the first and second STT times. If there is a significant variation in the progression of the STT time and the time value provided by the CPU-based timer, the source of the STT may be ignored, as illustrated by block 218, because it is not likely providing correct time information. If the difference in the CPU based timer is equal (or substantially equal) to the difference in the STT times, the STT may be continually processed as a valid time source, as illustrated in block 220. Further, a next STT may be acquired in block 222, and the process 200 may continue as shown.

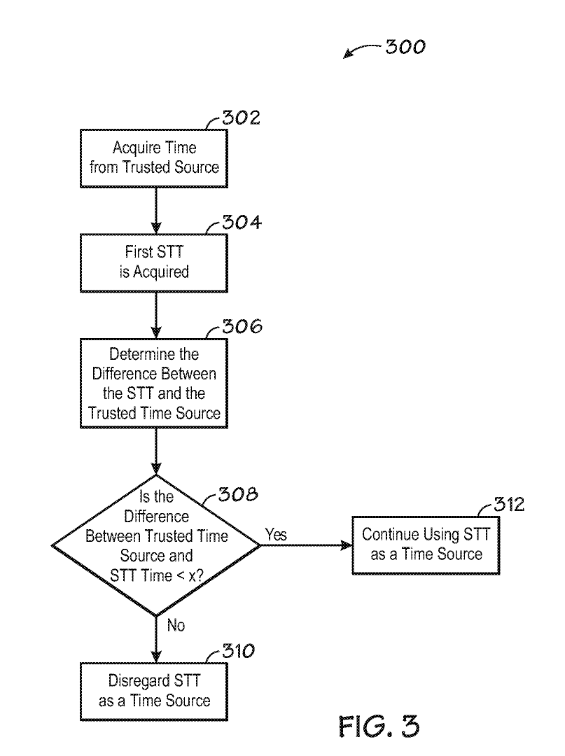

FIG. 3 is a process flow diagram that represents a method for acquiring and processing time information in accordance with an exemplary embodiment of the present invention. The exemplary process in FIG. 3 is generally designated by reference numeral 300 and may be implemented by a system or device (e.g., device 100) in accordance with present embodiments. The process 300 may operate to compare time data received from a new source with time data that was previously set by a trusted source to determine whether the new time data should be treated as valid. In one exemplary embodiment, a valid source may be determined and used to set the time in the device 100. Once the time is set, it may be free running based on a system clock (e.g., a software clock stored in the device 100). However, system clocks can be inconsistent time keepers. Accordingly, the time settings may be periodically updated from an outside source (e.g., a provider's signal). If the user switches (e.g., changes the channel on a television) to a source with invalid time data, an exemplary embodiment may avoid setting or updating the time and allow it to continue free running based on the last valid source. It should be noted that process 300 may be combined with process 200 in some embodiments of the present invention.

In the exemplary embodiment illustrated in FIG. 3, the process 300 begins with acquiring initial time information from a trusted source, as illustrated in block 302. Several methods may be utilized to acquire the initial time information. For example, an initial time setting, as input by a user, may be utilized as the trusted source. After acquiring the initial time information, process 300 continues to block 304, wherein a first STT is acquired from a provider. Once the STT is acquired, it is compared with the trusted time source and a difference between the two values is determined, as illustrated in block 306. In block 308 a determination is made as to whether the difference between the two values is greater than a designated value (e.g., a previously stored value for acceptable error). If the difference between the trusted time source and the STT is greater than a designated value, the STT is disregarded as a time source, as illustrated by block 310. Otherwise, if the difference between the two values is within the acceptable error, the STT is used as a time source, as illustrated by block 312.

In accordance with an exemplary embodiment of the present invention, if a user sets the time on a television, this time may be used to determine a list of trusted sources, which could then be used for updating purposes. A list may also be determined using an algorithm that compares times from multiple sources. If the algorithm determines that a number of sources substantially agree (e.g., a number of sources exceeding a given threshold agree), those sources found in agreement may be considered valid or may be defined as having a high level of trustworthiness. The user may also simply select certain trusted sources from a list of available sources. In another example, the cable OOB time or time from internet sources may be considered trusted sources.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A method comprising:
receiving a first external time signal from an external source;
determining a first internal time signal;
receiving a second external time signal from the external source;
determining a second internal time signal;
comparing the first external time signal to the second external time signal to determine an external time difference;
comparing the first internal time signal with the second internal time signal to determine an internal time difference; and
accepting the external source as a valid clock if the external time difference is within a range of the internal time difference.

2. The method of claim 1, comprising receiving a user-input tolerance value that defines the range.

3. The method of claim 1, wherein receiving the first external time signal comprises receiving a first system time table.

4. The method of claim 1, comprising setting a time and date feature based on the second external time signal when the external source is accepted as the valid clock.

5. The method of claim 1, comprising comparing the first external time signal with a trusted source time and ignoring the external source if the first external time signal does not substantially match the trusted source time.

6. The method of claim 1, wherein the trusted source is a user-selected source.

7. The method of claim 1, comprising storing the first external time signal in a memory.

8. The method of claim 1, wherein the second internal time signal is determined upon receiving the second external time signal.

9. The method of claim 1, wherein the first and second time signals include video-based time signals.

10. The method of claim 1, wherein the first and second internal time signals include CPU-based time signals.

11. A system comprising:
a first receiver configured to receive a first video-based time signal from a video source and a second video-based time signal from the video source;
a system clock configured to determine a first CPU-based time signal upon receiving the first video-based time signal and configured to determine a second CPU-based time signal upon receiving the second video-based time signal;
a first difference module configured to subtract the first video-based time signal from the second video-based time signal to produce a first time difference;
a second difference module configured to subtract the first CPU-based time signal from the second CPU-based time signal to produce a second time difference; and
a validation module configured to accept the video source as a valid time source if the first time difference substantially matches the second time difference.

12. The system of claim 11, comprising a tolerance module configured to receive a user-input tolerance value that defines an acceptable difference between the first time difference and the second time difference for accepting the video source as valid.

13. The system of claim 11, wherein the first video-based time signal comprises a first system time table.

14. The system of claim 11, comprising a time and date feature configured to be set based on the second video-based time signal when the video source is accepted as valid.

15. The system of claim 11, comprising a trusted source module configured to compare the first video-based time signal with a trusted source time and configured to ignore the first video-based time signal if the first video-based time signal does not substantially match the trusted source time.

16. A method, comprising:
receiving initial time information from a trusted source;
receiving secondary time information from a system time table transmitted by a time source;
determining a difference between the initial time information and the secondary time information;
determining whether the difference is within a tolerance range; and
ignoring the time source if the difference is outside the tolerance range.

17. The method of claim 16, comprising receiving the system time table into a cable receptor.

18. The method of claim 16, comprising comparing information from a plurality of time sources with the initial time information and defining a list of trusted providers based on the comparisons.

19. The method of claim 16, comprising determining the trusted source based on a comparison of multiple potential sources.

20. The method of claim 19, comprising designating a one of the multiple potential sources as the trusted source if it provides time information that substantially matches that of a majority of the multiple potential sources.
